(19) United States
(12) Patent Application Publication
(10) Pub. No.: US 2008/0110343 A1
(43) Pub. Date: May 15, 2008

(54) Electronic device with aromatic odor generating unit

(75) Inventor: Kuo-Yang Cheng, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/594,865

(22) Filed: Nov. 9, 2006

(51) Int. Cl. B03C 3/017

(52) U.S. Cl. 96/63

(57) ABSTRACT

An electronic device is provided. The electronic device includes a body, an aromatic odor generating unit, and a fan. The aromatic odor generated by the aromatic odor generating unit is exhausted from the body of the electronic device through an air outtake by air flow produced by the fan, so as to achieve an improved operation environment. In addition, a negative ion generating module is disposed on the electronic device; therefore, the aromatic odor can mix with the negative ions and then be exhausted from the body of the electronic device to provide the functions for invigorating people's spirits or satisfying the balancing of body physiques.

### BACKGROUND OF THE INVENTION

1. Field of Invention

The present invention relates to an electronic device, and more particularly, to an electronic device capable of yielding an aromatic odor and negative ions.

2. Related Art

In recent years, aromatic substances, such as essences, are popular and hot on the market. Aromatic substances are indispensable in the daily life of the masses, even affecting people's spirits and feelings, as it is generally appreciated that the aromatic odor of aromatic substances may have the effects of stabilizing moods and refreshment or have the functions of eliminating dirtiness and disease, etc.

Additionally, in nature, negative ions are naturally generated in various natural phenomena, such as, the spray splashed by waterfalls or rivulets in the forest, the fresh air produced from the photosynthesis of plants, the ultraviolet radiation of the sun, etc. Studies show that, absorbing these negative ions into the human body can directly benefit respiratory and pulmonary functions, accelerate the metabolism of cells, and enhance blood circulation and motivation of the heart, such that people are vigorous and feel pleasant. Furthermore, the negative ions can also assuage the autonomic nerve, eliminating symptoms such as insomnia, headache, backache, wind dampness, and high blood pressure. Therefore, nothing is better than strolling in the mountains, woods, or around waterfalls to enjoy negative ions. However, due to a life of high pace and busy work, modern people have few opportunities to enjoy themselves in the open air, or enjoy negative ions naturally in the mountains, woods, or around waterfalls.

Furthermore, with the development and progress of society, many electronic devices are playing more and more important roles in daily life. Especially for those always using computers for long times, the electronic devices generate electromagnetic waves and exhaust gas with lots of positive ions. It is generally agreed that, positive ions affect the normal ion balance in human body, thereby affecting the human health, especially for those using electronic devices for a long time in enclosed and separated offices.

Furthermore, of course, many kinds of negative ion products are sold on the market. Since the conventional negative ion products are manufactured as independent products, they cannot be used flexibly and conveniently when there are not enough outlets, or when electronic devices, such as notebooks, are used outdoors. Even the portable negative ion product is an additional burden.

Therefore, as for the conventional negative ion products, no desirable design integrating a negative ion product with an existing electronic device, such as a notebook computer, so as to eliminate additional indoor power sockets and an additional negative ion generating module, has been provided. Therefore, how to redesign an electronic device generating an aromatic odor to satisfy the olfactory enjoyment of the user and meanwhile generate negative ions like the air filter has become the development object of researchers in this field.

### SUMMARY OF THE INVENTION

In view of the above problems of the conventional art, the present invention provides an electronic device, so as to solve the problem that a conventional notebook computer is used for electronic operation only and unable to provide the functions for invigorating people's spirits or satisfying the balancing of body physiques.

In order to achieve the aforementioned object, the present invention provides an electronic device, which includes a body, an aromatic odor generating unit, and a fan. The fan is used to generate an air flow to scatter the aromatic odor released by the aromatic odor generating unit to air through the body. Therefore, the user can not only operate the electronic device but also smell the aromatic odor for invigorating working spirits at same time.

In addition, in order to provide a better working environment, a negative ion generating module is added into the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of an electronic device; and

FIG. 2 is a schematic view of an assembly of the storage box, the fan, and the aromatic odor generating unit.

### DETAILED DESCRIPTION OF THE INVENTION

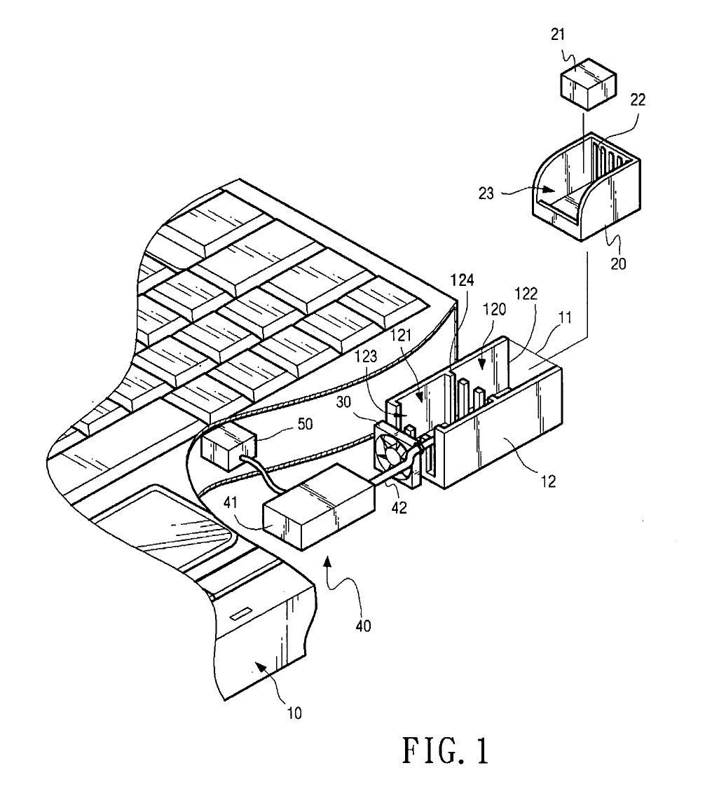

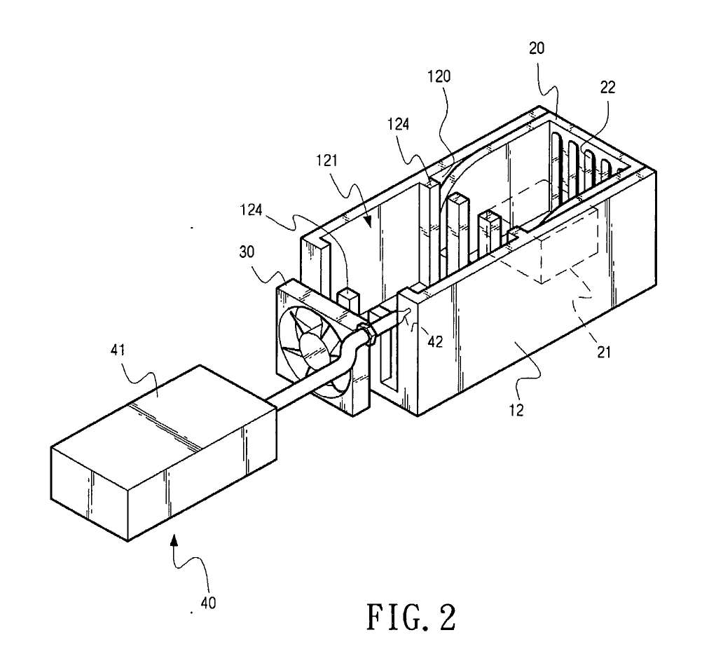

Firstly, with reference to FIGS. 1 and 2, the present invention provides an electronic device. The electronic device includes a body 10 having a case and a power supply, an aromatic odor generating unit 21, and a fan 30. The electronic device may be a portable device (such as a notebook computer) or desktop device (such as a desktop computer, a server, or a modem).

The aromatic odor generating unit 21 may be an essential oil or sandalwood for producing an aromatic odor. It may be a scented soap or a sponge absorbing essence oil. The odor may be apple odor, flower odor, fragrant odor, and so on. The aromatic odor generating unit 21 may be accommodated on a storage box 20, and the storage box 20 has a plurality of vent holes 22 and an air flow guiding opening 23. Besides, these vent holes 22 are located on the place corresponding to that of the air outtake 11 of the body 10 of the electronic device. Therefore, when the storage box 20 put in the air outtake 11, the fan 30 being electrically connected to a power supply 50 of the body 10 of the electronic device may generate air flow and the air flow may be passing through the aromatic odor generating unit 21 from the air flow guiding opening 23. Then, the aromatic odor generated by the aromatic odor generating unit 21 is exhausted from these vent holes 22 and the air outtake 11, so as to spread the aromatic odor surrounding the body 10 of the electronic device.

With reference to FIGS. 1 and 2 again, the present invention provides a frame 12 within the body 10 of the electronic device. The frame 12 has a first accommodation space 120 and a second accommodation space 121. In addition, the first accommodation space 120 and the second accommodation space 121 are connected by a plurality of bars 124; hence, air may interflow within the first accommodation space 120 and the second accommodation space 121. The first accommodation space 120 has an opening 122 corresponding to the air outtake 11, so that the storage box 20 may slide into the first accommodation space 120 from the air outtake 11 as shown in FIG. 2. Besides, the first accommodation space 120 has another air intake 123 for the air flow generated by the fan 30 to pass through. Therefore, air flow may exhaust from the air intake 123 through the air flow guiding opening 23, the aromatic odor generating unit 21, these vent holes 22, the air outtake 11 to outside of the body 10 of the electronic device.

In addition, as shown in FIG. 1, there is another negative ion generating module 40 disposed on the body 10 of the electronic device. The negative ion generating module 40 includes a high voltage discharge unit 41 being electrically connected to the power supply 50 and a discharge tip 42. The discharge tip 42 is extending the second accommodation space 121, so as to let the discharge tip 42 to be surrounded by air. So, when the high voltage discharge unit 41 makes the discharge tip 42 discharge, the air surrounding the discharge tip 42 is decomposed and the negative ions are generated. Also, when the air flow generated from the fan 30 is passing through the air intake 123, the negative ions are brought to the aromatic odor generating unit 21 and mixed with the aromatic odor. Then the aromatic odor mixed with the negative ions is carried out to outside of the body 10 of the electronic device by the air flow.

Through the electronic device provided by the present invention, at least the following functions can be achieved:

1. The present invention provides an electronic device. Through implementing and employing the electronic device, the user can readily gain the aromatic odor upon using information electronic products, such as, computers, servers, and modems in daily life, such that the effects, such as stabilizing moods, refreshing, and relaxing as if close to nature, can be achieved, and the user may not feel exhausted or tired even if he or she has worked for a long time.

2. The present invention provides an electronic device. Through implementing and employing the electronic device, the user can gain the aromatic odor in close distance when using information electronic products, such as computers, servers, and modems in daily life. Additionally, when the aromatic substance is an essential oil or a sandalwood essential oil, the user feels comfortable both physically and mentally, and enjoys the aromatic odor. Since the electronic device also produces negative ions, it functions like a common air filter.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An electronic device, comprising:
a body having a case and a power supply for outputting an power source, wherein the case includes at least one an air outtake;
a fan electrically connected to the power supply for generating an air flow;
an aromatic odor generating unit for producing an aromatic odor, the aromatic odor being disposed on flowing path of the air flow, the aromatic odor being carried out to the air outtake by the air flow; and
a negative ion generating module being electrically connected to the power supply for generating negative ions, the negative ions being disposed on flowing path of the air flow, such that the aromatic odor and the negative ions being mixed together and thus being exhausted from the air outtake by the air flow.

2. The electronic device as claimed in claim 1, wherein the electronic device is a notebook computer.

3. The electronic device as claimed in claim 1, wherein the aromatic odor is an essential oil or a sandalwood.

4. (canceled)

5. The electronic device as claimed in claim 1, wherein the negative ion generating module comprises:
a discharge tip disposed on the flowing path of the air flow and surrounded by air; and
a high voltage discharge unit electrically connected to the power supply, wherein the high voltage discharge unit makes the discharge tip discharge to decompose the surrounded air and generate the negative ions.

6. The electronic device as claimed in claim 1, further comprising:
a frame including a first accommodation space for accommodating the aromatic odor generating unit, wherein the first accommodation space has an opening corresponding to the air outtake and an air intake for the air flow flowing through, the air flow flowing from the air intake through the first accommodation space and then exhausting from the opening and the air outtake.

7. The electronic device as claimed in claim 6, further comprising:
a storage box disposed on the first accommodation space for accommodating the aromatic odor generating unit, wherein the storage box can be moved out of the body from the first accommodation space through the opening and the air outtake, wherein when the storage box is disposed on the first accommodation space, places corresponding to the air intake and the air outtake respectively in the storage box has a vent hole and an air flow guiding opening, so as to let the air flow pass the storage box and exhaust from the vent hole and the air outtake.

8. The electronic device as claimed in claim 7, further comprising a negative ion generating module disposed on the flowing path of the air flow, wherein the negative ion generating module being electrically connected to the power supply and generating negative ions exhausted from the air outtake by the air flow.

9. The electronic device as claimed in claim 8, wherein the negative ion generating module comprises:
a discharge tip disposed on the flowing path of the air flow and surrounded by air; and
a high voltage discharge unit electrically connected to the power supply, wherein the high voltage discharge unit makes the discharge tip to decompose the surrounded air and generate the negative ions.

10. The electronic device as claimed in claim 9, wherein the frame further comprises a second accommodation space for accommodating the discharge tip, wherein the discharge tip is accommodated on the second accommodation space and surrounded by the air and the air flow passes the second accommodation space and the first accommodation space in subsequence and then flows out from the air outtake.
